(19) United States
(12) Patent Application Publication
(10) Pub. No.: US 2006/0161511 A1
(43) Pub. Date: Jul. 20, 2006

(54) Systems, methods, and media for determining electronic document usage

(76) Inventors: Viktors Berstis, Austin, TX (US); Randolph Michael Forlenza, Austin, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(21) Appl. No.: 11/039,534

(22) Filed: Jan. 20, 2005

(51) Int. Cl. G06F 7/00

(52) U.S. Cl. 707/1

(57) ABSTRACT

Systems, methods and media for determining the usage of an electronic document are disclosed. More particularly, hardware and/or software for determining the aggregate usage for an electronic document received from one or more users are disclosed. Embodiments include receiving from one or more users an indication of their usage of the electronic document, aggregating the usage indications received, and creating document utilization information for the electronic document. Further embodiments include transmitting the document utilization information to the one or more users. Other embodiments include displaying to the user an indication of the document utilization information. Electronic documents may be in any type of format.

### FIELD OF INVENTION

The present invention is in the field of data processing systems and, in particular, to systems, methods and media for determining and aggregating electronic document usage.

### BACKGROUND

Personal computer systems are well known in the art. They have attained widespread use for providing computer power to many segments of today's modern society. Personal computers (PCs) may be defined as a desktop, floor standing, or portable microcomputer that includes a system unit having a central processing unit (CPU) and associated volatile and non-volatile memory, including random access memory (RAM) and basic input/output system read only memory (BIOS ROM), a system monitor, a keyboard, one or more flexible diskette drives, a CD-ROM drive, a fixed disk storage drive (also known as a “hard drive”), a pointing device such as a mouse, and an optional network interface adapter. Examples of such personal computer systems are International Business Machine Corp.'s (IBM's) ThinkCentre™, ThinkPad™, Aptiva™, and IntelliStation™ series of personal computers. The use of mobile computing devices, such as notebook PCs, personal digital assistants (PDAs), tablet PCs, sophisticated wireless phones, etc., has also become widespread. Mobile computing devices typically exchange some functionality or performance when compared to traditional PCs in exchange for smaller size, portable power, and mobility.

The widespread use of PCs and mobile computing devices in various segments of society has resulted in a reliance on computer systems both at work and at home, such as for telecommuting, news, stock market information and trading, banking, shopping, shipping, communication in the form of hypertext transfer protocol (http) and e-mail, as well as other services. Many of these functions take advantage of the communication abilities offered by the Internet. Such connectivity has facilitated unprecedented amounts of collaboration and sharing of information between individuals, both within organizations and outside organizational structures. This collaboration has resulted in individuals having access to and sharing vast amounts of information, often in the form of electronic documents.

Electronic documents are digitized documents that contain text, graphics, photographs, etc., and can be read by various computer systems. Electronic documents may contain text or graphics, and a wide variety of file formats have been used, such as Portable Network Graphics (PNG), Joint Photographic Experts Group (JPEG), Graphics Interchange Format (GIF), Tag Image File Format (TIFF), Microsoft Word (DOC), etc. Other file formats capable of handling text and graphics include Hypertext Markup Language (HTML) and Adobe Systems Inc.'s Portable Document Format (PDF). For many applications, electronic documents, particularly PDF documents, have supplanted printed material for the dissemination of information, as many journals, newsletters, books, articles, etc., and now distributed either exclusively or non-exclusively in electronic form.

While electronic documents possess improved qualities in many ways over hardcopies, such as cost, ease of distribution, and time to prepare, disadvantages of electronic documents when compared to paper documents do exist. One deficiency of electronic documents is that it is difficult to find the most interesting or useful part of an electronic book or other document. With a paper books, individuals may observe which pages are the most worn or the pages to which the book naturally opens due to frequent reading of those pages. One can easily discern which book in, say, a library is the most useful based on its wear, and one can also often find the most useful part of the book by noting the wear caused by frequent reading. Because of the fixed nature of an electronic document, electronic documents fail to provide such indications of frequently-read or particularly useful sections of the document.

There is, therefore, a need for an easy and effective system to determine electronic document usage, particularly to help assist readers of electronic documents in ascertaining frequently used portions of electronic documents.

### SUMMARY OF THE INVENTION

The problems identified above are in large part addressed by systems, methods and media for determining electronic document usage. Embodiments include receiving from one or more users an indication of their usage of the electronic document and aggregating the usage indications for the received electronic document. Embodiments may also generally include creating document utilization information for the electronic document, wherein the document utilization information is based on the received usage indications. Further embodiments may include transmitting the document utilization information to the one or more users and archiving the document utilization information. In some embodiments, the usage of the electronic document may include an indication of how much time the user spent viewing a particular section of the electronic document.

Another embodiment provides a machine-accessible medium containing instructions effective, when executing in a data processing system, to cause the system to perform a series of operations for determining electronic document usage. The series of operations generally includes receiving from one or more users via a network an indication of their usage of the electronic document and aggregating the usage indications for the electronic document received from the one or more users. The series of operations may also generally include creating document utilization information for the electronic document, wherein the document utilization information is based on the received usage indications. Further embodiments may include a series of operations for transmitting the document utilization information to the one or more users and archiving the document utilization information.

A further embodiment provides an electronic document usage determining system. The electronic document usage determining system may include a communications module for receiving document usage information from one or more users via a network, where the document usage information provides an indication of the users' viewing of an electronic document. The electronic document usage determining system may further include an aggregator module for aggregating the document usage information from the users and a usage analysis module for creating document utilization information based on the aggregated document usage information, where the document utilization information provides an indication of the usage of the electronic document by the one or more users. Further embodiments may include where the communications module is adapted to transmit document utilization to the one or more users via the network.

Another embodiment includes a method providing for tracking usage of an electronic document by a user, transmitting an indication of the usage of the electronic document by the user, and receiving document utilization information for the electronic document, where the document utilization information is based on the usage of the electronic document by a plurality of users. The embodiment may also generally include displaying an indication of the document utilization information to the user. Further embodiments may include saving the indication of the usage of the electronic document by the user and saving the document utilization information. Other embodiments may include analyzing the document utilization information and the usage of the electronic document by the user.

A further embodiment provides an electronic document display system. The electronic document display system may include a user communications module for receiving input from a user, a memory module that is adapted to store an electronic document, and a document reader that is adapted to display to the user the electronic document and an indication of the usage of the electronic document by other users. Further embodiment of the electronic document display system may also include a communications module for receiving document utilization information via a network, where the document utilization information includes an indication of the usage of the electronic document by other users.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts an environment for a system for determining electronic document usage according to one embodiment;

FIG. 2 depicts one embodiment of a document computer system of the electronic document usage system of FIG. 1;

FIG. 3 depicts one embodiment of an aggregator server of the electronic document usage system of FIG. 1;

FIG. 4 depicts an example of a flow chart for determining electronic document usage according to one embodiment;

FIG. 5 depicts an example of a flow chart for determining electronic document usage according to another embodiment; and

FIG. 6 depicts an example of a flow chart for receiving and displaying electronic document usage information according to one embodiment.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Systems, methods and media for determining the usage of an electronic document are disclosed. More particularly, hardware and/or software for determining the aggregate usage for an electronic document received from one or more users are disclosed. Embodiments include receiving from one or more users an indication of their usage of the electronic document, aggregating the usage indications received, and creating document utilization information for the electronic document. Further embodiments include transmitting the document utilization information to one or more users. Other embodiments include displaying to the user an indication of the document utilization information. Electronic documents may be in any type of format.

The disclosed embodiments help provide document utilization information to a user viewing an electronic document. Embodiments disclose tracking the usage of an electronic document by a plurality of users using document computer systems. The usage information may then be transmitted to an aggregator server, where the usage information for the plurality of users may be aggregated and document utilization information for the particular electronic document may be created. The document utilization information provides an indication of the usage of the electronic document by the plurality of users and may be transmitted to the users. A document reader on the computer system may display an indication of the document utilization information along with the electronic document so that the user may see how other users have utilized the electronic document.

By seeing how other users have utilized the document, a user may easily and quickly find important, interesting, or relevant portions of the electronic document, replicating the benefits of worn or used reference books or other publications in the paper-based libraries, etc. For example, a user may, in one embodiment, be able to go to the section of an electronic document that other users have spent the most time viewing, which is likely a very relevant section to any user.

While specific embodiments will be described below with reference to particular configurations of hardware and/or software, those of skill in the art will realize that embodiments of the present invention may advantageously be implemented with other substantially equivalent hardware and/or software systems.

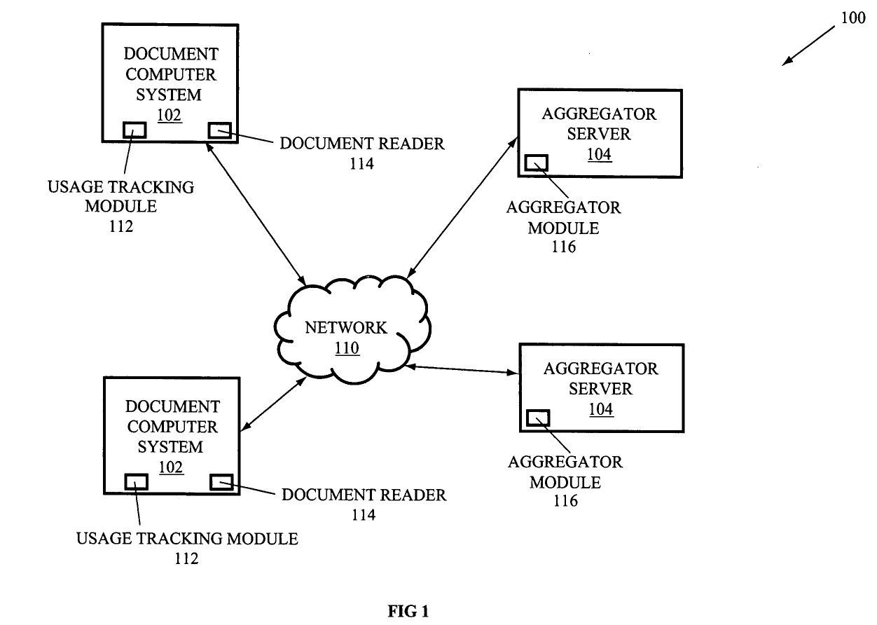

Turning now to the drawings, FIG. 1 depicts an environment for a system for determining electronic document usage according to one embodiment. In the depicted embodiment, document usage system 100 includes a plurality of document computer systems 102 in communication with a network 110. The depicted document usage system 100 also includes one or more aggregator servers 104 in communication with network 110 for aggregating document usage information. In the document usage system 100, the document computer systems 102 and aggregator servers 104 may be located at the same location, such as in the same building or computer lab, or may be remote. While the term “remote” is used with reference to the distance between the components of the document usage system 100, the term is used in the sense of indicating separation of some sort, rather than in the sense of indicating a large physical distance between the systems. For example, any of the components of the document usage system 100 may be physically adjacent or located as part of the same computer system in some network arrangements.

Electronic documents are digitized documents that contain text, graphics, photographs, etc., and can be read by various computer systems. Electronic documents may contain text or graphics and may use any type of file format, such as PNG, JPEG, GIF, TIFF, DOC, HTML, PDF, RTF, TXT, MCW, etc. Any type of document may be used for electronic documents, such as books, eBooks, articles, journals, World Wide Web (Web) pages, etc. Electronic documents may, in one embodiment, include multiple sections and/or other means of organizing the document, such as chapters, pages, paragraphs, sentences, volumes, etc.

Network 110 may be any type of data communications channel, such as the Internet, an intranet, a LAN, a WAN, an Ethernet network, a wireless network, a proprietary network, a broadband cable network, etc. Those skilled in the art will recognize, however, that the invention described herein may be implemented utilizing any type of data communications channel.

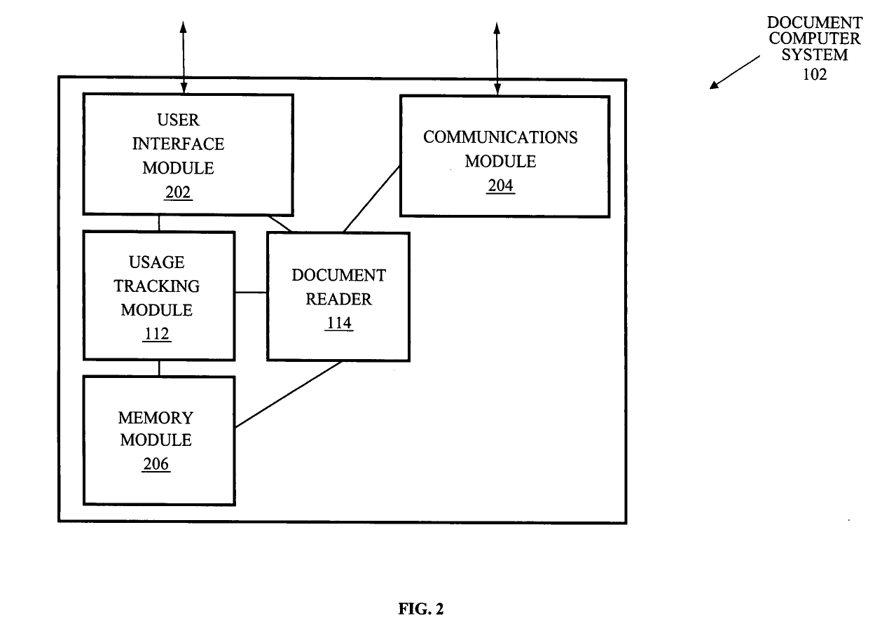

Document computer systems 102 may include personal computers, workstations, servers, mainframe computers, notebook or laptop computers, desktop computers, personal digital assistants (PDAs), tablet or palm personal computers, set-top boxes, mobile phones, wireless devices, or the like. Each document computer system 102 may include a usage tracking module 112 and a document reader 114. A user may use a document computer system 102 to view or read electronic documents using. In one embodiment, document computer systems 102 may be a personal computer that has electronic document reader software executing on the system. In another embodiment, document computer systems 102 may be a handheld, mobile device such as a tablet personal computer or PDA with an on-board electronic document reader. Document computer systems 102 are described in more detail in relation to FIG. 2.

Usage tracking module 112 may track the user's usage of an electronic document being viewed or otherwise utilized on the document computer system 102, such as by using the document reader 114. Usage of an electronic document may include opening or closing the electronic document, creating or deleting bookmarks in the electronic document, time spent with the electronic document open, printing the electronic document, e-mailing or otherwise transmitting the electronic document, etc. In one embodiment, the usage tracking module 112 tracks the usage of the electronic document based on a particular section of the electronic document being used, such as a page, chapter, paragraph, sentence, etc. or any other portion of the document.

In one embodiment, the usage tracking module 112 may first start a timer whenever a new section of an electronic document is displayed to determine the amount of time spent viewing a section of the electronic document. Typically in a window-based graphical user interface (or windowing system), the current window being manipulated is said to be “in focus”, which means keystrokes such as page-down and page-up would pertain to the window in focus, rather than another window. Thus timing would continue in this embodiment for the section displayed in the window as long as the window is in focus and that section of the electronic document is still in view within that window. If the user performs a scrolling or page-up/down operation on that window, timing for any section which leaves the view would then be stopped. The final time value for the given section may then be added to a memory location designated to retain the total time spent on that particular electronic document section. Each electronic document section of interest would have its own total time value stored in an associated memory location, and whenever that section is visible, a timer would be started by the usage tracking module 112 to keep track of the time it is visible. After the electronic document is closed by the user, the accumulated time values for each of the electronic document sections are stored either within the document file itself or in some other designated file. On subsequent viewings, the prior time values would be used as the starting values for the time spent in a section, so that additional viewings would add on to the time spent viewing that section of the electronic document. Timings may overlap in some cases. For example, there may be a timing accumulator for a paragraph as well as one for the whole page in which it resides. The paragraph timer would run as long as the paragraph is visible. The page timer would run as long as the page is visible. However, depending on scrolling, the whole page may not be visible (stopping its timer) while the paragraph within the page is still entirely visible (keeping its timer going).

The usage tracking module 112 may determine whether the user is actively viewing the electronic document (or section of an electronic document) based on user input (from keyboard entries, mouse movement, or the like) to ensure that the user has not abandoned the document computer system 102. Abandonment may be measure by a passage of time, activation of a screen saver, lack of user input, etc. In this embodiment, time spent after the document computer system 102 has been abandoned by the user is not counted as time spent viewing the electronic document. A time interval may be used to estimate when a user stops viewing an electronic document, such as by not counting time spent after, say, a ten minute interval after the last user input. This provides a more accurate measurement of how much time a user spends viewing an electronic document or a section thereof. If the user abandons the computer leaving a particular section of the electronic document in view (with its timer going), these last time values would be discarded and would not be added to the accumulation if some designated amount of time had elapsed (e.g., 15 minutes or the time to turn on the screen saver). However, if the user moves his mouse, presses any keyboard key or uses any other manual input devices on the computer, the time accumulation would continue and be counted up to the last such manual input.

In one embodiment, the usage tracking module 112 may determine which electronic document (or section) is being viewed when multiple electronic documents are open. For example, sometimes a user may open a section of an electronic document for reference in a window and then open a second window where he may be doing some other work related to the document section which is visible. In this example there are two windows visible, side by side, but the document window may not have focus as the viewer is primarily viewing the other window. The usage tracking module 112 may accumulate usage time in this embodiment for any time where the electronic document window is still wholly, or mostly, visible in such a situation. In this example, only if more than some designated portion (e.g., 50%) of the window were covered would usage times stop accumulating. Usage tracking module 112 may use any suitable methodology for determining usage time.

Document reader 114 may be any software module that is used to display an electronic document such as browsers, dedicated electronic document reader software packages (such as Adobe Systems Inc.'s Adobe Acrobat® or Reader), or other software. Examples of currently existing document readers 114 include Adobe Systems Inc.'s Adobe Acrobat® or Reader, Microsoft Corporations' Word or Reader, Palm Corporation's Reader, and MobiPocket Reader.

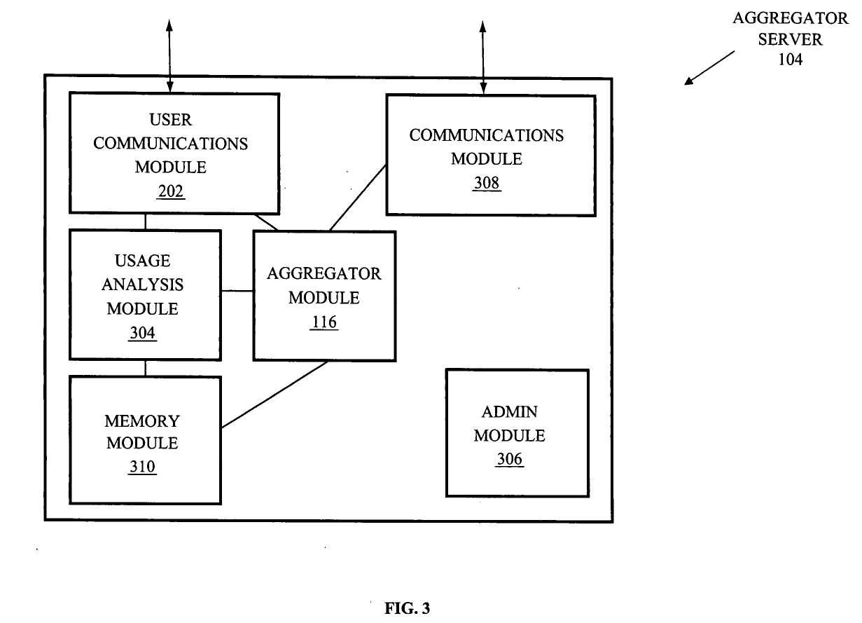

Aggregator servers 104 may be executing on one or more personal computers, workstations, servers, mainframe computers, notebook or laptop computers, desktop computers, or the like. In one embodiment, the aggregator server 104 may be a server in communication with a plurality of document computer systems 102 via network 110. Aggregator servers 104 are described in more detail in relation to FIG. 3. In one embodiment, a single aggregator server 104 may be used. In this embodiment, the aggregator server 104 facilitates determining electronic document usage by receiving indications of electronic document usage from the document computer systems 102 and processing the data. The aggregator server 104 of this embodiment may include local storage, such as a hard drive, or may include other storage, such as a hard drive array, remote storage over network 110, a Redundant Array of Inexpensive Disks (RAID) system, etc.

In another embodiment, a plurality of aggregator servers 104 may be utilized. In this embodiment, one aggregator server 104 may be designated as a primary aggregator server 104 so that document computer systems 102 will first attempt to transmit usage information to it. Any of the aggregator servers 104 in this embodiment, however, may receive information from the document computer systems 102. The plurality of aggregator servers 104 may replicate their collected information with each of the other aggregator servers 104 so that if one is temporarily disabled or permanently removed, the usage information will still be available.

Referring now to FIG. 2, there is shown one embodiment of a document computer system 102 of the electronic document usage system 100 of FIG. 1. In the embodiment of FIG. 2, the computer system 102 includes a user communications module 202, a communications module 204, a memory module 206, a usage tracking module 112, and a document reader 114. The usage tracking module and the document reader 114 are described in relation to FIG. 1. The user communications module 202 may be used, in one embodiment, to receive input from the user and to display information to or otherwise communicate with the user. For example, the user communications module 202 may receive user input entered via a user input device, such as keyboard, mouse, pen, voice command system, joystick, buttons, stylus, etc. A user may input any type of information, such as requests to open or close an electronic document, a request to move forward or backward in an electronic document, a request to create or delete a bookmark, a request to go to a particular section of an electronic document, etc. The user communications module 202 may also communicate information to the user, such as by monitor or display device, printer, sound card, etc.

The communications module 204 may transmit document usage information for electronic documents to an aggregator server 104 via the network 110. The communications module 204 may also receive information, such as document utilization information from an aggregator server 104. Memory module 206 may store any type of information, such as user preferences, electronic documents, document usage information, document utilization information, etc. Any type of memory may be used, including fixed or removable media, permanent or temporary storage, volatile or non-volatile memory, hard drives, CD-ROMs, etc.

Referring now to FIG. 3, there is shown one embodiment of an aggregator server 104 of the electronic document usage system 100 of FIG. 1. In the embodiment of FIG. 3, the aggregator server 104 includes an aggregator module 116, a usage analysis module 304, an administration module 306, a communications module 308, and a memory module 310. As described in relation to FIG. 1, the aggregator module 116 may collect and aggregate electronic document usage information received from users on one or more document computer systems 102. Time spent viewing a section of a document may be used as a proxy for the value, utility, or relevance of the information included in that section.

The usage analysis module 304 may provide more sophisticated analysis of the document usage information collected and aggregated by the aggregator module 302. For example, the usage analysis module 304 may be used to sort and/or analyze the usage information by type of user, class of user, type of usage (e.g., printing, viewing, etc.), different timeframes (e.g., giving more weight to more recent usage), etc. In one embodiment, an administrator or other user may customize the type of analysis that is performed by the usage analysis module 304.

The administration module 306 may access administrative data and to perform various administrative tasks, such as adding or deleting users, setting up passwords, adding or deleting electronic documents, etc. Permissions to different aspects of the electronic document usage system 100 may be restricted to those users with the appropriate needs, training, and authority. In a further embodiment, a user with appropriate access may configure the type of analysis performed by the usage analysis module 304 or aggregator module 116, add new electronic documents to the document usage system 100, change archiving settings, add or delete aggregator servers 104, etc. The communications module 308 may transmit any type of information, such as document utilization information, to any of the document computer systems 102 or other computer systems via the network 110. The communications module 308 may also receive document usage information from document computer systems 102.

Memory module 310 may store any type of information, such as user preferences, electronic documents, document usage information, or document utilization information. Any type of memory may be used, including fixed or removable media, permanent or temporary storage, volatile or non-volatile memory, hard drives, CD-ROMs, etc. In one embodiment, document identification information may also be stored in memory module 310. Document identification information may include a document name or identifier, creation or modification date, edition, publisher, document type (e.g., DOC, PDF, etc.), etc. Document usage information may, in one embodiment, be stored in a table in the memory module 310 organized by document identification information. When no user has provided data for a particular electronic document, an indication that no data exists may also be stored.

The functions of the various modules of FIGS. 2 and 3 may be combined or distributed in any fashion within the document computer system 102 and aggregator server 104, respectively. For example, the functions of the aggregator module 116 and the usage analysis module 304 of the aggregator server 104 may be combined into one module. In another example, some of the functions of the administrator module 306 may be performed by a module of the document computer system 102 instead of the aggregator server 104. Other modifications and combinations are possible. In an alternative embodiment, the functions of the document computer system 102 and the aggregator server 104 may be combined into one system, making the network 110 unnecessary. In this embodiment, the aggregator server 104 may provide for one or more users who access the aggregator server 104 to view an electronic document. The document usage of each user may be tracked and aggregated so that document utilization information for the users of the aggregator server 104 may be created. This embodiment may be particularly useful when a group of users share one computer and access the same electronic documents.

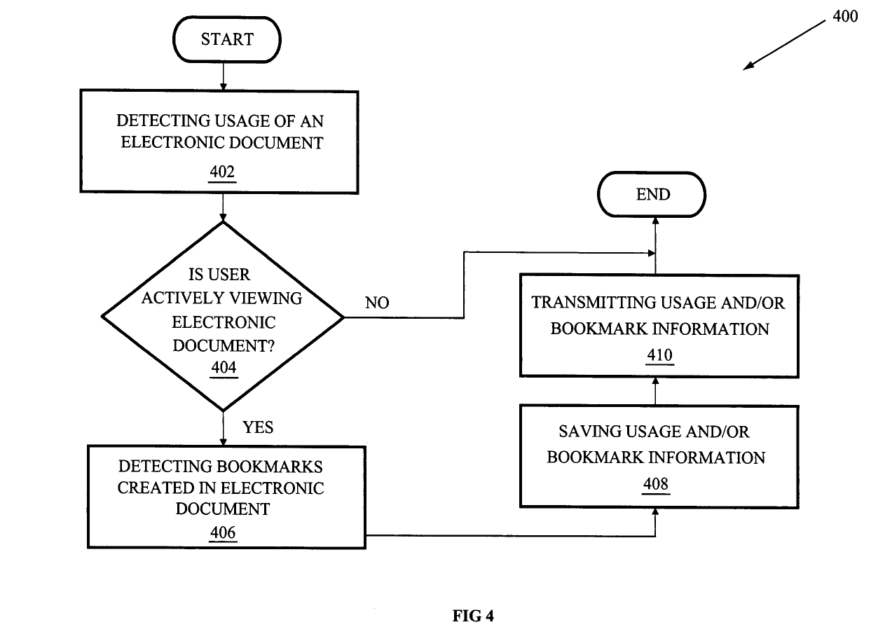

FIG. 4 depicts an example of a flow chart 400 for determining electronic document usage according to one embodiment. The method of flow chart 400 may be performed, in one embodiment, by a document computer system 102. Flow chart 400 begins with element 402, detecting usage of an electronic document. In element 402, usage tracking module 112 may track usage of an electronic document by a user, such as a user using a document reader 114 on a document computer system 102 to view an electronic document. Usage of an electronic document may include opening or closing the electronic document, time spent with the electronic document open, printing the electronic document, e-mailing or otherwise transmitting the electronic document, etc. In one embodiment, an indication of the usage of the electronic document is the time a user spends viewing a particular section. If a user spends a relatively long period of time viewing a particular section, it is evidence that the user finds value in the information in that section. Similarly, if the user quickly moves past a section, it may reflect less value in that section. Quickly skipping over a section may reflect a lower value than never seeing a section at all, as an unseen section may have more potential to have value than one that is quickly reviewed and moved past.

Flowchart 400 continues to decision block 404, where the usage tracking module 112 of a document computer system 102 may determine whether the user is actively viewing the electronic document. Decision block 404 is optional and may be used where it is desired to have more accurate document usage information. If decision block 404 is not used, the function would simply continue to element 406 as if the response to decision block 404 was affirmative. If it is determined in decision block 404 that the user is not actively viewing the document, the function terminates, as any indications of usage of the electronic document by the user will not be valid. If the user is actively viewing the electronic document (or if decision block 404 is not used), the function continues to element 406.

Optional element 406, detecting bookmarks created in the electronic document, is the next element in flowchart 400. The creating or deletion of bookmarks in an electronic document is a type of usage of an electronic document that provides an even more direct relation to the value a user places on the information on that page. A user may create a bookmark on a page of an electronic document when they desire to be able to quickly get back to that page or do not want to forget the location of the information on that page. Accordingly, a bookmark created on a page is good evidence that the user finds the information on the page of value. Similarly, if a user deletes a bookmark, it is good evidence that the user no longer finds the information of value on that page.

Flowchart 400 continues to element 408, saving usage and/or bookmark information. In this element, any document usage information, including bookmark information, may be saved to any type of storage, such as memory module 210. In element 410, any document usage information, including bookmark information, may be transmitted, after which flowchart 400 terminates. Information about the user and/or document computer system 102 may also be transmitted along with the document usage information to one or more aggregator servers 104 via network 110.

In one embodiment, the location, name, or other identifying information for an aggregator server 104 may be stored locally at computer system 102. Information related to aggregator servers 104 may be stored with the file containing the electronic document, but it may also be stored in an associated but separate file, as part of document reader 206, in memory module 210, or anywhere else. In another embodiment, a list of aggregator servers 104 is stored. In this embodiment, an effort would be made to transmit usage and/or bookmark information to the first aggregator server 104 on this list. If the first aggregator server 104 was unavailable, element 410 would move to the next aggregator server 104 on the list, and so on. This allows the method of flow chart 400 to operate and successfully transmit information even in the event of aggregator server 104 failure, deletion, renaming, disabling, etc.

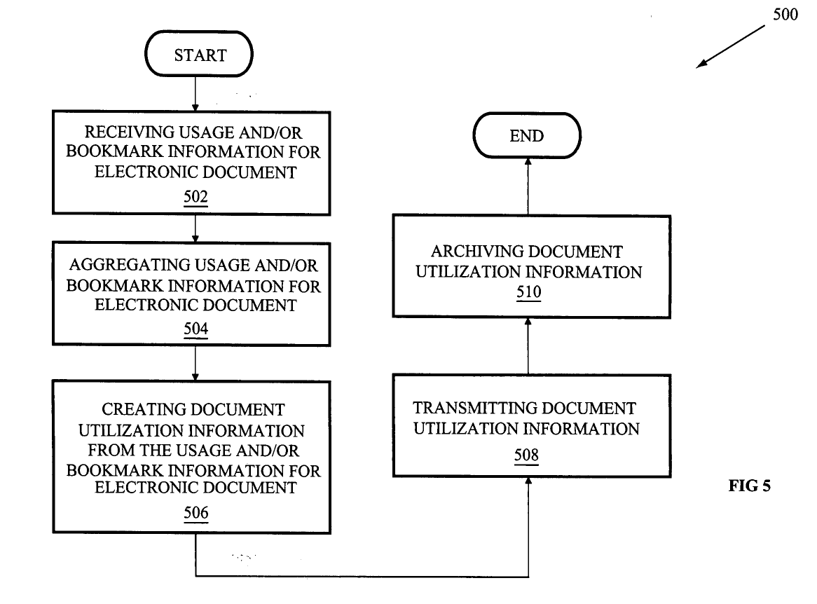

FIG. 5 depicts an example of a flow chart 500 for determining electronic document usage according to another embodiment. The method of flow chart 500 may be performed, in one embodiment, by an aggregator server 104. Flow chart 500 begins with element 502, receiving document usage information, including bookmark information. In one embodiment, the communications module 308 of an aggregator server 104 receives document usage information from a plurality of users on document computer systems 102. The communications module 308 may also receive information about the user and/or document computer system 102 that transmitted the information along with the document usage information.

Flowchart 500 continues to element 504, aggregating usage information (including bookmark information) for a particular electronic document. In element 504, an aggregator module 116 may collect and aggregate document usage information from multiple users and/or document computer systems 102. Aggregation may occur at any level of fidelity (with portions of any sizes), including by page (collecting usage of pages among multiple users), at higher levels of fidelity (e.g., chapters, articles, etc.) or lower levels of fidelity (e.g., paragraphs, sentences, etc.). In one embodiment, the aggregator server 104 may determine the amount of time users cumulatively spent on each section of a particular electronic document in element 504. In another embodiment, the aggregator server 104 may determine the percentage of users who bookmarked each page of an electronic document in element 504. Any document usage information may be aggregated, in any fashion at any level of fidelity, in this element.

Flowchart 500 continues to element 506, creating document utilization information from the aggregated usage information for a particular document. Document utilization information is information resulting from any level of analysis of the aggregated usage information of element 504. In one example, document utilization information for a particular electronic document includes the relative amounts of time spent on each page of an electronic document by aggregated users. For example, the document utilization information could indicate that users spent an average of 30 seconds on page 1, two minutes on page 2, and 13 seconds on page three, and so on. A bar chart or histogram-like display could be created illustrating the time spent on each page. Using this visual representation, a user could see that page 2, in this example, is probably the most valuable of the electronic document pages.

In other embodiments, more sophisticated processing may be performed. In one example, usage information may be determined based on a class of users. For example, users can be divided based on some sort of classification (e.g., experts, physicists, programmers, PhD candidates, etc.) and document utilization information may be created for that classification. A physicist, for example, is likely more interested in what other physicists have considered valuable in a document than what chemists considered important. In other embodiment, algorithms are used to combine different types of usage information into document utilization information. In this embodiment, bookmark information, time spent on a page or section, which pages were printed out, etc., can all be combined to provide an indication of the value of a particular page or section. In one example, bookmark information could be weighted 30%, time viewing weighted 40%, and printing or e-mailing weighted 30%. Any type of processing is possible, and particular types of processing might be requested by users or administrators, set up as defaults, may be used in response to particular types of data, etc.

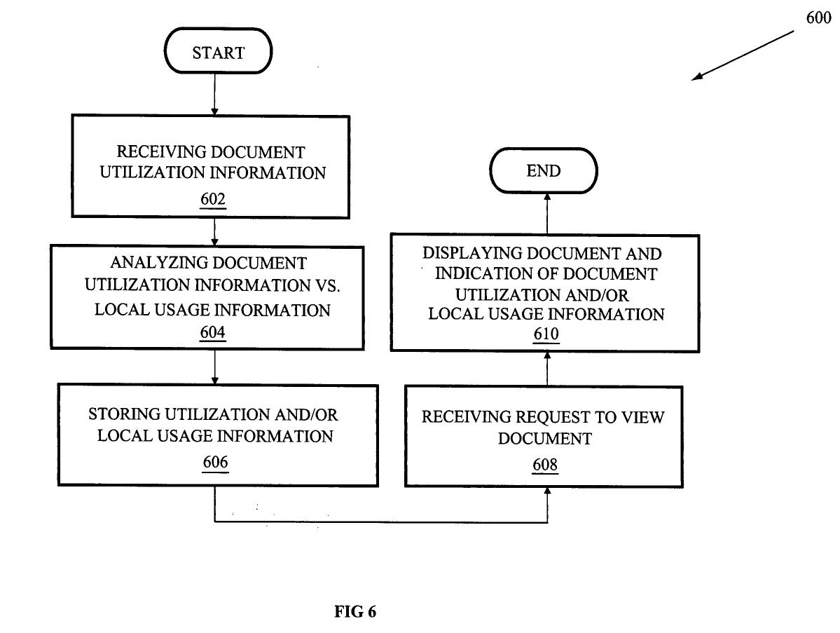

Flowchart 500 continues to optional element 508, transmitting document utilization information to, for example, users on document computer systems 102 via network 110 so that the information may be utilized by the document readers 206 on those document computer systems 102, as described in more detail in relation to FIG. 6. In another embodiment, the document utilization information may be transmitted to a remote server or storage facility, an administrator, a document publisher, etc. A document publisher, for example, may add document utilization information to electronic documents that will be distributed. In this way, document utilization information may be used by users on document computer systems 102 without network connections or without access to document usage system 100.

Flowchart 500 then continues to optional element 510, archiving document utilization information, after which the method terminates. In element 510, the document utilization information and any other information, such as the received document usage information, may be archived at a local or remote server, other aggregator servers 104, etc. This allows the information to be recovered in the event an aggregator server 104 is lost. In one embodiment, each aggregator server 104 replicates its information on the other aggregator serves 104, so that any aggregator server 104 may serve as the primary one and/or perform any necessary tasks in the event that the any of the aggregator servers 104 are unavailable.

FIG. 6 depicts an example of a flow chart for receiving and displaying electronic document usage information according to one embodiment. The method of flow chart 600 may be performed, in one embodiment, by a computer system 102 with a document reader 206. Flow chart 600 begins with element 602, receiving document utilization information. Document utilization information may be received, in one example, from an aggregator server 104 via the network 110.

Flowchart 600 continues to element 604, analyzing document utilization information and any document usage information. In this optional element, the document utilization information, which contains aggregate information from a plurality of users, may be compared to local document usage information, such as from the user using the computer system 102. This element may be of benefit to a user as a a user might find value in seeing how their usage compared to that of others. Any type of analysis may be performed, such as finding similarities or differences in usage, finding the most used pages or sections, finding the common bookmarks, etc. In element 606, the document utilization information and/or any local usage information, or the results of analysis of the two, may be stored locally or remotely, such as on a local hard drive. In one embodiment, document utilization information may be stored in a file located with the file for the electronic document. In another embodiment, document utilization information may be stored in the same file as the electronic document, such as by utilizing empty fields, appending the document utilization information, etc.

Flowchart 600 continues to element 608, receiving request to view an electronic document. The request may be received from a user using any means to enter their desire to open the document, such as by selecting it to be opened from a list from within the document reader 206, by double-clicking an icon associated with the electronic document, etc. In element 610, the electronic document and/or an indication of the document utilization information and/or the local usage information may be displayed to the user. The electronic document may be displayed utilizing document reader 206 or other program. The document utilization information and/or local usage information may also be displayed utilizing document reader 206 or other program, either automatically when the electronic document is opened, upon user request, after a certain time, upon a specific action, etc. The indication of the information may take any form, such as visual display, auditory display, etc. In one embodiment, the sections that have had the most usage are provided with a visual indication, such as being highlighted, a different color, marked in table of contents, graphical representation of a tattered corner as in a paper book, etc. Any type of information may be communicated, and any means may be used to communicate the information to the user.

The methods of FIGS. 4, 5 and 6 provide a straightforward mechanism for determining and displaying the usage for an electronic document. In one example that illustrates some benefits of such a method, a collection of articles in PDF form may be distributed to an interested group, such as professors across the world. Each professor may access the articles within the electronic document in a way that they find useful. Each would naturally focus on particular portions of the electronic document that were particularly useful to them. Their usage of the electronic document could be gathered locally on their document computer systems 102 and transmitted to a central aggregator server 104. The aggregator server 104 would then collect and aggregate all of the usage information and create document utilization information. In this example, the document utilization information could include information on how much time the average reader spent on each article and in each section. This document utilization information could then be transmitted back to the users (on their document computer systems 102). When any of these professors, or any other readers, opened the electronic document, they would see some indication of the document utilization information. For example, any articles or sections that were heavily accessed by many professors could be highlighted or otherwise identified. This would allow a professor just getting the electronic document to immediately see which articles and sections their peers found most useful or interesting, saving them the time and trouble of having to review the entire document. Many other combinations and examples are, of course, possible.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates methods, systems, and media for determining electronic document usage. It is understood that the form of the invention shown and described in the detailed description and the drawings are to be taken merely as examples. It is intended that the following claims be interpreted broadly to embrace all the variations of the example embodiments disclosed.

What is claimed is:

1. A method for determining the usage of an electronic document, the method comprising:
receiving from one or more users an indication of their usage of the electronic document;
aggregating the usage indications for the electronic document received from the one or more users; and
creating document utilization information for the electronic document, wherein the document utilization information is based on the received usage indications.

2. The method of claim 1, further comprising transmitting the document utilization information to the one or more users.

3. The method of claim 1, further comprising archiving the document utilization information.

4. The method of claim 1, further comprising receiving from one or more users an indication of a bookmark created in the electronic document.

5. The method of claim 1, wherein the usage of the electronic document from at least one user includes an indication of how much time the user spent viewing a particular section of the electronic document.

6. A machine-accessible medium containing instructions effective, when executing in a data processing system, to cause said data processing system to perform operations comprising:
receiving from one or more users an indication of their usage of the electronic document;
aggregating the usage indications for the electronic document received from the one or more users; and
creating document utilization information for the electronic document, wherein the document utilization information is based on the received usage indications.

7. The machine-accessible medium of claim 6, further comprising transmitting the document utilization information to the one or more users.

8. The machine-accessible medium of claim 6, further comprising archiving the document utilization information.

9. The machine-accessible medium of claim 6, further comprising receiving from one or more users an indication of a bookmark created in the electronic document.

10. The machine-accessible medium of claim 6, wherein the usage of the electronic document from at least one user includes an indication of how much time the user spent viewing a particular section of the electronic document.

11. An electronic document usage determining system, the system comprising:
a communications module for receiving document usage information from one or more users on document computer systems, the document usage information providing an indication of the users' usage of an electronic document;
an aggregator module for aggregating the document usage information from the users; and
a usage analysis module for creating document utilization information based on the aggregated document usage information, the document utilization information providing an indication of the usage of the electronic document by the one or more users.

12. The system of claim 11, wherein the communications module is adapted to transmit document utilization information to the one or more users via the network.

13. A method for displaying electronic document utilization information, the method comprising:
tracking usage of the electronic document by a user;
transmitting the indication of the usage of the electronic document by the user;
receiving document utilization information for the electronic document, the document utilization information being based on the usage of the electronic document by a plurality of users; and
displaying an indication of the document utilization information to the user.

14. The method of claim 13, further comprising saving the indication of the usage of the electronic document by the user.

15. The method of claim 13, further comprising analyzing the document utilization information and the usage of the electronic document by the user.

16. The method of claim 13, further comprising saving the document utilization information.

17. The method of claim 13, further comprising receiving a request from the user to view the electronic document.

18. The method of claim 13, further comprising determining whether the user is actively viewing the electronic document.

19. The method of claim 13, further comprising detecting a user input, wherein the user input indicates that the user is actively viewing the electronic document.

20. The method of claim 13, wherein the usage of the electronic document includes an indication of how much time the user spent viewing a particular section of the electronic document.

21. An electronic document display system, the system comprising:
a user communications module for receiving input from a user;
a memory module, the memory module being adapted to store an electronic document; and
a document reader, the document reader being adapted to display to the user the electronic document, wherein the document reader is further adapted to display an indication of the usage of the electronic document by other users.

22. The system of claim 21, further comprising a communications module, the communications module being adapted to receive document utilization information via a network, the document utilization information including an indication of the usage of the electronic document by other users.

23. The system of claim 22, further comprising a usage tracking module, the usage tracking module being adapted to track the user's usage of the electronic document.
